(19) United States
(12) Patent Application Publication
(10) Pub. No.: US 2009/0192836 A1
(43) Pub. Date: Jul. 30, 2009

(54) AUTOMATED TEST SYSTEM PROJECT MANAGEMENT

(76) Inventor: Patrick Kelly, San Diego, CA (US)

Correspondence Address: LAW OFFICE OF MARK WISNOSKY, 3060 6TH AVE., # 8, SAN DIEGO, CA, 92103, US

(21) Appl. No.: 12/018,968

(22) Filed: Jan. 24, 2008

(51) Int. Cl. G06Q 10/00; G06Q 99/00

(52) U.S. Cl. 705/7; 705/1

(57) ABSTRACT

Test system project management processes, algorithms and software are described. The combination of the processes, algorithms and software provides a means to effectively management new the testing procedures for new product introductions from initial specification of the testing requirements all the way through implementation. The automated system allows the work to be broken down into defined sub-projects such that individual experts will have defined and documented tasks contributing to the completion of the testing regime. Tracking and evaluation algorithms are also presented. The system has been found to reduce the risk of new product introductions through thorough documentation and monitored implementation. The system also includes negotiation schema that provide optimized supplier selection to design and complete the testing system at an effective cost.

### TECHNICAL FIELD

Embodiments of the invention relate to methods to automate the design and execution of test systems for new products such as electronic devices, mechanical devices and software.

### BACKGROUND OF THE INVENTION

New products present unique challenges to not just their original design to provide a desired functionality but also the debugging and testing of the systems to be certain the new functionality works as planned under a variety of use scenarios and environments. Frequently in bringing a new product to market the majority of the development time is discovering and fixing bugs or defects. Testing new products has become a specialty in both the consumer and industrial electronics fields. New functionality generally requires new customized test modes. Testing might require new equipment or at least custom programming of existing electronic test and measurement devices. Often new interfaces to the product being tested must be designed and activating the new product will require custom programming to access new functionality. Delays in testing may result in development delays. The accompanying delays in time to market may determine whether a new product is a success or failure.

Poorly designed test procedures may result in defective products reaching the consumer. Delays and defects may cost a company millions of dollars and have affected the stock price of even the largest of the world's electronics manufacturers. Recent reports indicate the need for improvements. In 2006 and 2007 computer manufacturers recalled nearly 10 million new models of laptop computers due to batteries overheating and in some cases igniting. The recall cost the battery manufacturer approximately $400 million. Test regimes that covered use scenarios might have caught the problem before it reached customers. In 2007 Microsoft took a $1 billion charge against operating expenses due to defects in a single product gaming system. Media analysis speculated that Microsoft may be good at discovering software defects, but electronic hardware provides new challenges.

There is a significant commercial need for new invention in test system design and execution. All modes of products require testing before introduction to the consumer. Mechanical devices, medical products, software and electronic devices all have requirements for testing across environments to be encountered in consumer use. Test system design has become a critical business often separate from the product design. Test system design and management challenge project management skills that are rarely found in the design engineer or his management. Often the test procedures are outsourced to firms that specialize in product testing. The independence provides not just a specialist in the field but also an unbiased search for product defects without a built in conflict of interest of the designer policing himself. However linking design to test often requires skill sets that neither the test nor the design engineer possess. Specifications must be designed for testing; a vendor set must be found that has the appropriate skills and resources and access to equipment that match the test specifications. A system is then needed to select the optimal vendor from amongst a set of candidates. The vendors must then be critically managed to ensure timely design and operation of the test protocols. A means to visualize progress on a project with multiple parallel paths is needed. Success on the project should be used to feed back to the vendor selection process such that the best set of initial candidate vendors are selected for future projects. Heretofore the process has been manual and hidden in the mind of the test system project manager. Often the project manager had some but not all of the skills required to go from design specification to tested product release. The project manager needs tools to automate and supplement his skill set and to guide a generalized test system design.

### SUMMARY OF THE INVENTION

A system comprising a standardized method to gather test system requirements and to design and execute test plans is described. The system allows a non-expert in electronic testing to efficiently to gather requirements, design and specify a test plan, select suppliers and execute the test plan for a new product. The term “product” is used throughout this specification to be generally any new or revised product. Nonlimiting examples include mechanical devices, medical devices, electronic devices and software.

The system overcomes the deficiencies of the current manual technology for designing a test system that will address anticipated failure modes of the new product, documentation requirements, means to select suppliers, and, execution of the plan. The system creates documentation applicable to not just the test system but also reference documents for the product under test as well. The system uses experience both past and current, captured through a rating system, and a pseudo-auction system to obtain the best supplier and price. The system further includes algorithms to track progress for a test system project and creates and updates a database of past projects to ensure learning for the future. The system is largely automated in a web-based application.

### BRIEF DESCRIPTION OF THE DRAWINGS

In order that this invention can be more readily understood, reference will now be made by way of example to the accompanying drawings.

FIG. 1 is a depiction of a networked environment in which embodiments of the invention may be practiced.

FIG. 2 is a depiction of a computing device upon which the invention may be practiced.

FIG. 3 is a block diagram of the main component embodiments of the invention.

FIG. 4 is a block diagram of a specification process embodiment of the invention.

FIG. 5 is a block diagram of an automated interview process embodiment of the invention.

FIG. 6 is a web page image for an automated interview process embodiment of the invention.

FIG. 7 is a web page image showing a help page embodiment of the automated interview process.

FIG. 8 is a block diagram of an automated document generation process.

FIG. 9 is a block diagram of an expert selection process.

FIG. 10 is a flow chart for a supplier selection process embodiment of the invention.

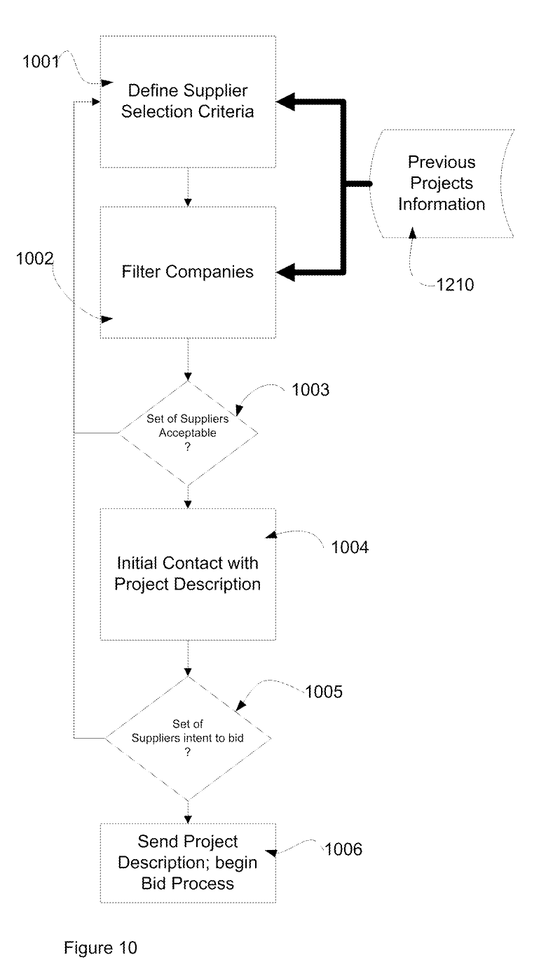

FIG. 11 is a block diagram for a pseudo auction embodiment of the supplier selection process.

FIG. 12 is a block diagram of a project implementation management process embodiment of the invention.

FIG. 13 is a block diagram of a pre-implementation dashboard embodiment.

FIG. 14 is block diagram of an implementation dashboard embodiment.

FIG. 15 is a web page image of a customer evaluation embodiment of the invention.

### DETAILED DESCRIPTION

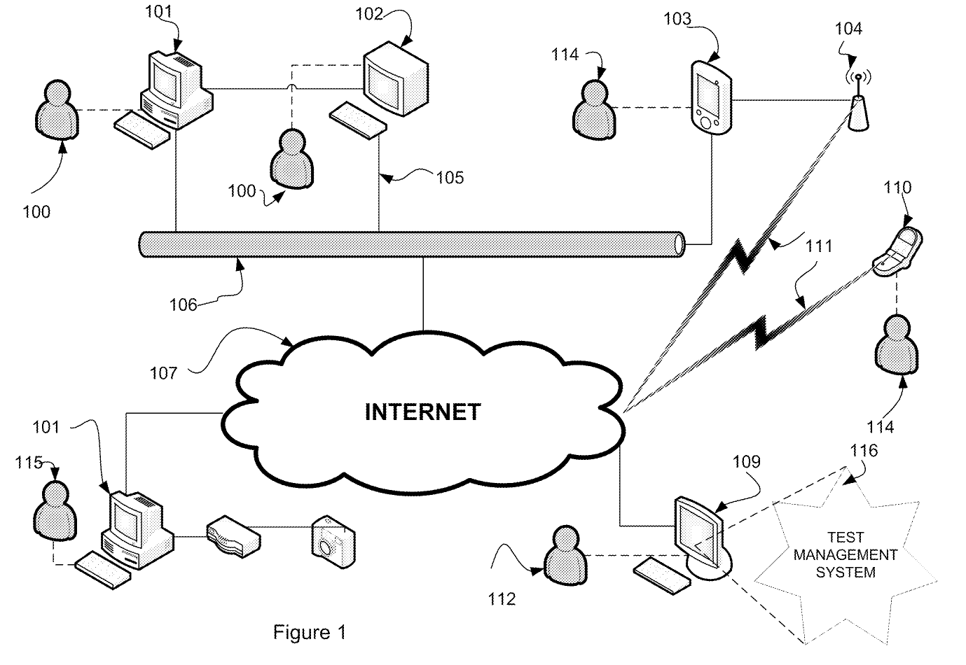

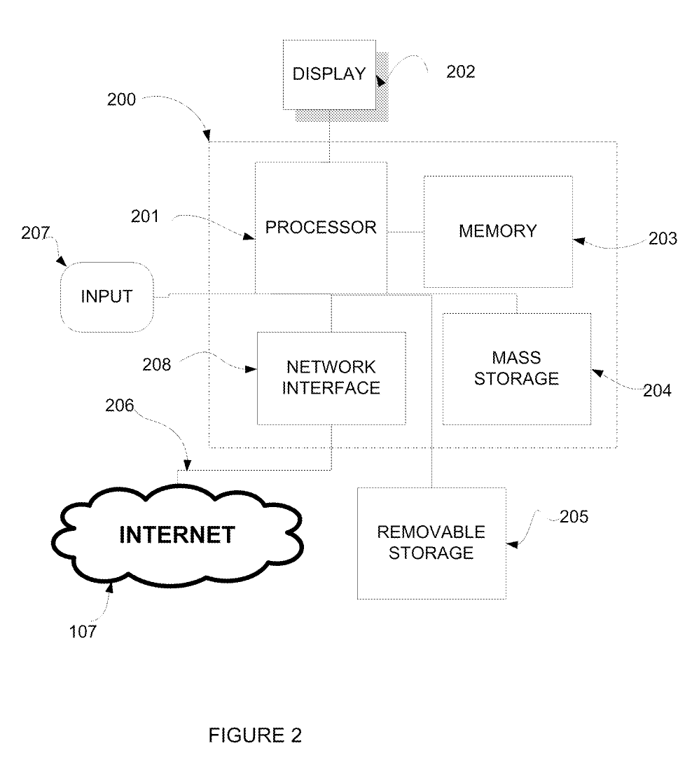

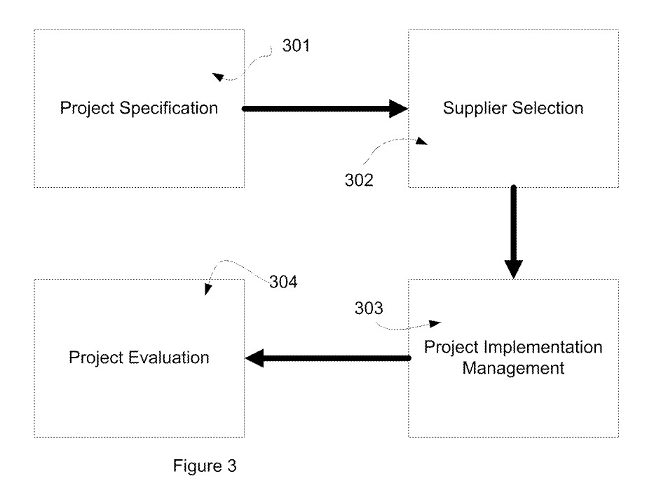

FIG. 1 depicts a networked computer environment consistent with an embodiment of the invention. Users of the system may be based in an office 100 or mobile 114 and may gain access through personal computers 101, terminals 102, personal data assistance 103 and cell phones 110. Access may be through wired 105 or wireless 111 connections to the internet 107. Users may also be interconnected through a local area network 106. Other persons who are involved in embodiments of the invention include project managers 112 and experts 115. They likewise are connected through the internet 107 to the office bound 100 and mobile 114 users. Access of the project managers and experts may be through a similar set of products and connection means as described for the users, both mobile and not. Not all possible combinations of connection are shown. The test management system 116 may be operational on a server 109. FIG. 2 depicts a block diagram of a computing device 200 upon which embodiments of the invention may be practiced. A processor 201 executes commands of the inventive program that may be stored in machine readable media such as random access memory 203, fixed the mass storage 204 or removable storage 205 of the computing device 200. The present invention may also be downloaded as a computer program product from a remote computer such as a server to a local requesting computer such as a client either through the internet or any of a number of wired or wireless means for communication of computing devices as are known in the art. The programmed embodiment of the invention executes commands to prompt user for input regarding the project parameters through project definition, implementation and evaluation phases and displays the prompts upon the computing device display 202. A network interface means 208 is included to allow a connection 206 to the internet 107 that allows interaction with other users of the system. An input means 207 is used to capture user responses that may then be stored in any of the memory means 203, 204, 205 for further manipulation as will be apparent through the following discussion. The inventive program may be encoded in any computer language that includes facilities for memory access, display, accepting input and a communicating connection to other users. Another embodiment of the invention includes a computer readable storage device upon which the programs described in the remainder of this specification are encoded. FIG. 3 depicts a high level organization block diagram of embodiments of the invention. A project specification 301 module includes an automated interview process that defines characteristics of the product to be tested as well as the business needs of the user. An automated expert system prompts the user for input to create a project specification document. In some embodiments the questions are customized based upon user response. Experts may be called in as required. Relevant parameters are automatically captured in a project document that may then be used to guide subsequent phases of the testing project. In one embodiment the web page created through the interview process becomes the project document. Once a project is specified a supplier or suppliers may be selected 302 to execute the project for the user. Typically such suppliers are experts in particular aspects of the testing equipment, procedures, software and data analysis. The particular required set of suppliers' qualifications are identified in the project specification document. Embodiments of the supplier selection 302 include means to select suppliers based upon technical and business qualifications, past performance, desire to participate in the currently defined project and a negotiated price. In another embodiment of the invention the price negotiation takes place through a pseudo reverse auction. The auction is termed “pseudo” in that the rules for engagement for the auction process may be customized for each particular project or even project situation and may not include a requirement that the low bidder wins the project. The bidding system includes a set of rules to optimally guide the bidding process to result in a selected supplier. Once a supplier is selected the testing of the product begins. An automated project implementation management module 303 tracks progress against project milestones and provides feedback to stakeholders such as engineers and management as to not just testing progress but also test results. One embodiment includes an automated dashboard that may be used to easily judge both the progress and results. Another project implementation management embodiment utilizes the completed project specification to place objective criteria upon completion of project milestones. Such completion criteria may be used to trigger payments or other project activities. Embodiments of the invention further include an evaluation process 304. The evaluation process captures the results of the present project along objective and subjective vectors of overall user satisfaction, delivery of required technology by the supplier, supplier communication skills, schedule and delivery by the supplier against milestones and a cost parameter based upon comparison of suppliers bids for the project against other competing suppliers. In another embodiment the evaluation process is operational throughout the project specification, bidding and implementation phases. Supplier ratings may thereby be captured even before project completion. In one embodiment the suppliers' characterization includes comparison of the supplier's characteristic bidding practices. In another embodiment the supplier characteristic bidding practices includes a percentile ranking of the supplier against other suppliers on the basis of the value of the bids. The information in the evaluation process is recorded in a database and fed back into the preceding processes of specification 301, supplier selection 302 and management 303 to provide guidance to current projects based upon previous projects' experiences.

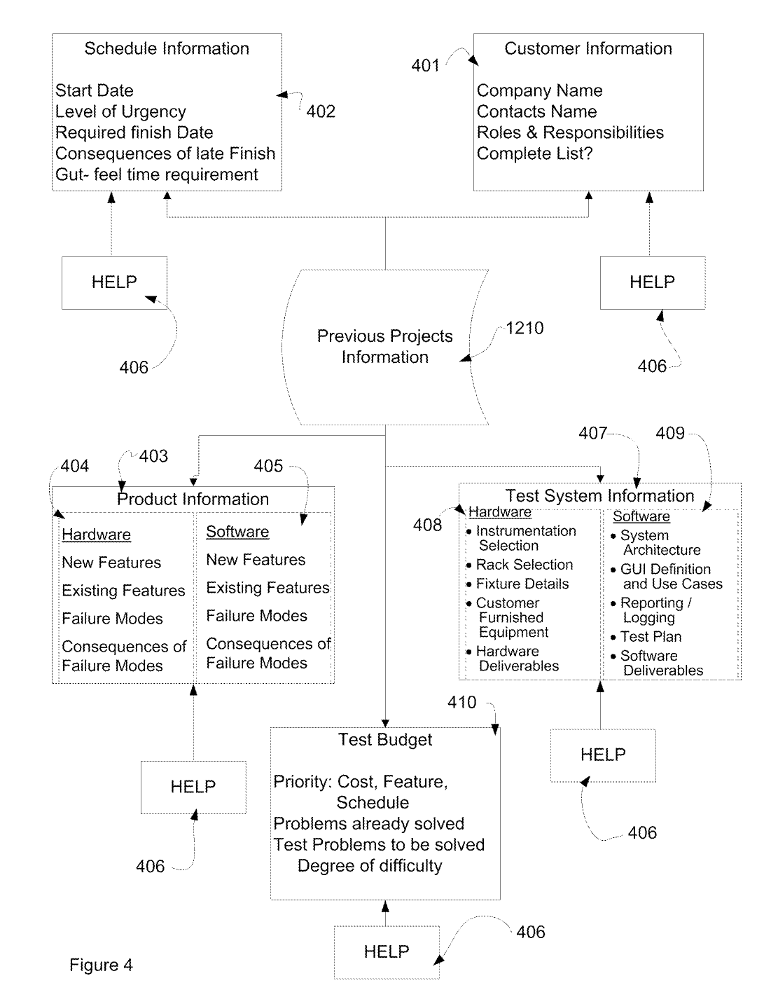

FIG. 4 shows a block diagram for the specification process of the invention. Specifications are generated through an automated, structured interview process that includes categories of customer information 401, schedule requirements 402, information regarding the product to be tested 403, information regarding the testing to be performed 404 and testing budget 405. Experience from previous projects 1210 is fed back into the interview process for each of the categories. Each category additionally includes a help function 406 that provides guidance and example answers such that the interview process provides the detailed relevant information required to create a robust specification for the testing project. In one embodiment the automated interview process to define the specifications for the project prompts for information in the particular sequence of:

1. Project Title

2. Schedule Information

3. General Project Idea

4. Gathering Existing Information

5. Budget Information

6. Non-Disclosure Agreement (NDA)

7. Hardware Specification
7.1 Instrumentation Selection
7.2 Rack Selection
7.3 Fixture Details
7.4 Customer Furnished Equipment
7.5 Hardware Deliverables

8. Software Specification
8.1 Software Architecture
8.2 GUI Definition and Use Cases
8.3 Reporting/Logging
8.4 Test Plan
8.5 Software Deliverables

9. Self-Test and Calibration

The inventor has discovered that this particular ordering then allows for most efficient collection of a complete set of data required of a specification. In another embodiment the ordering of the question set also allows the responses to earlier questions to modify the subsequent questions.

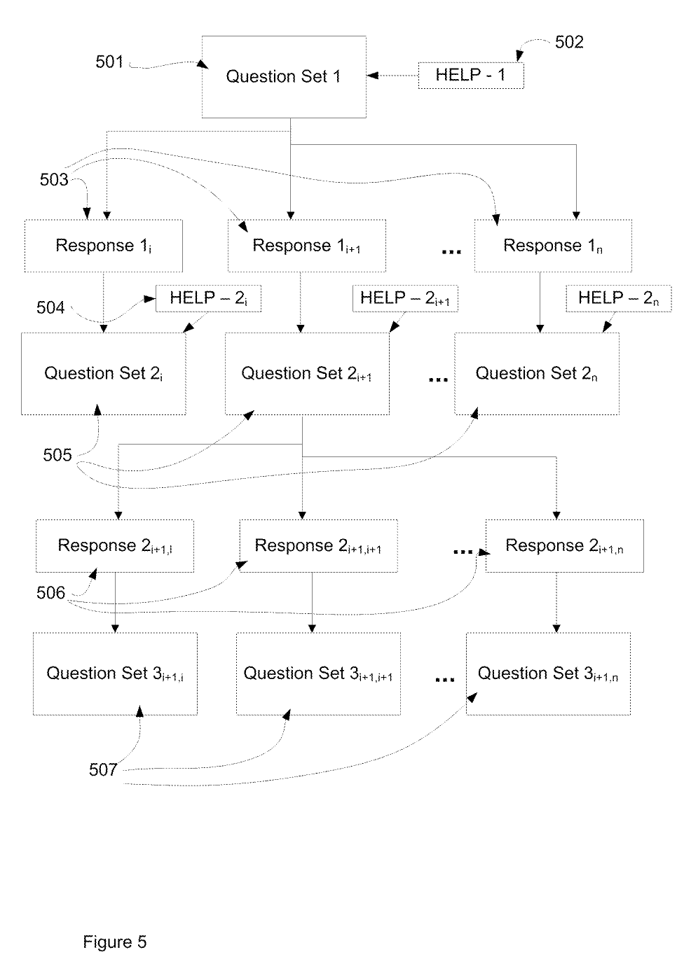

Another embodiment, diagrammed in FIG. 5, includes an automated questioning scheme in which responses to earlier questions modify the subsequent questioning process. A first question set includes a help page 502 that is unique for that question. The help page guides the responder into answering the first question into a categorical response 503 selected from a category i to n. The categorical response then determines which of a multitude of question sets 505 are selected for the second question. Each of the question sets 505 has a unique help page 505 selected for that question set that again guides the user to respond into a set of categorical responses 506. The categorical response then determines which of a plurality of question sets will be asked on the next round 507. The process continues until required information for the specification has been gathered. The question set is thereby a unique combination of questions that are tailored to the particular project being specified.

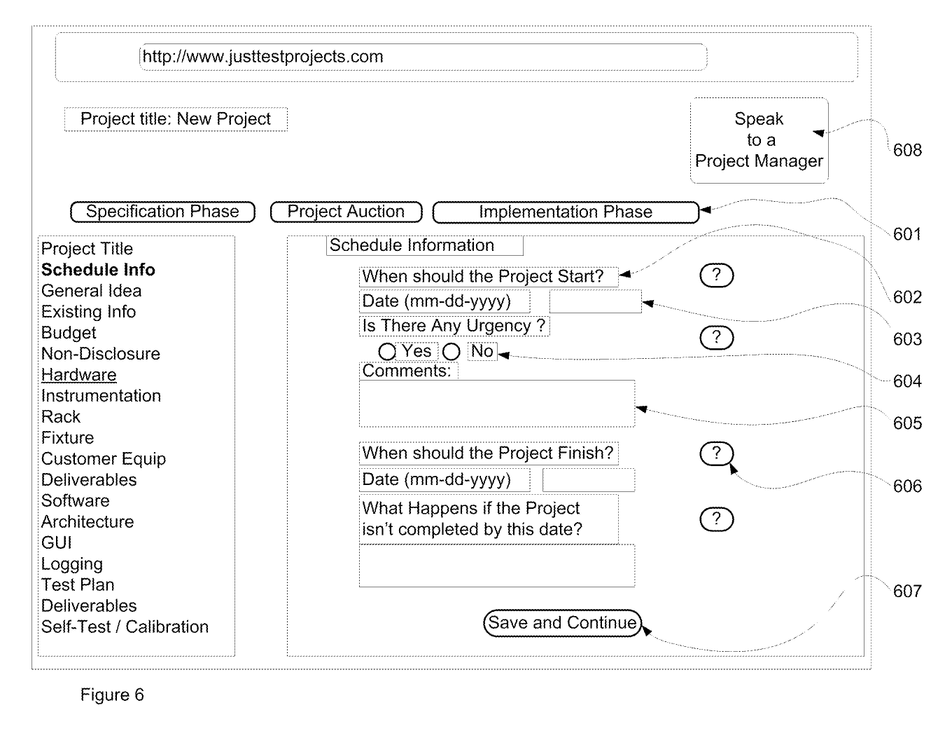

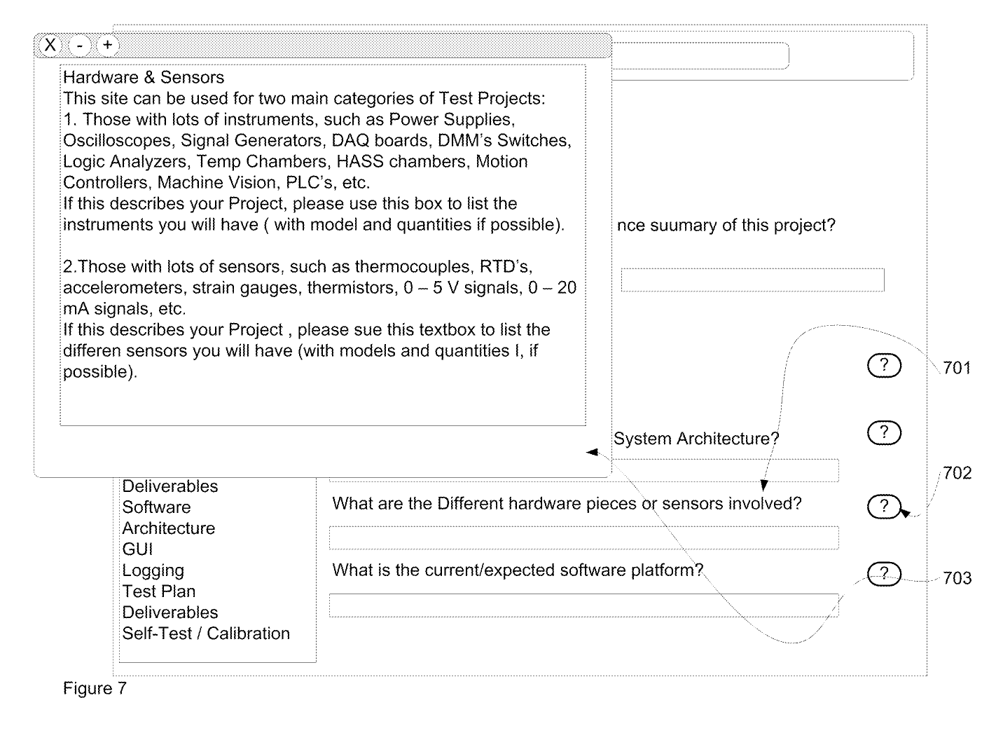

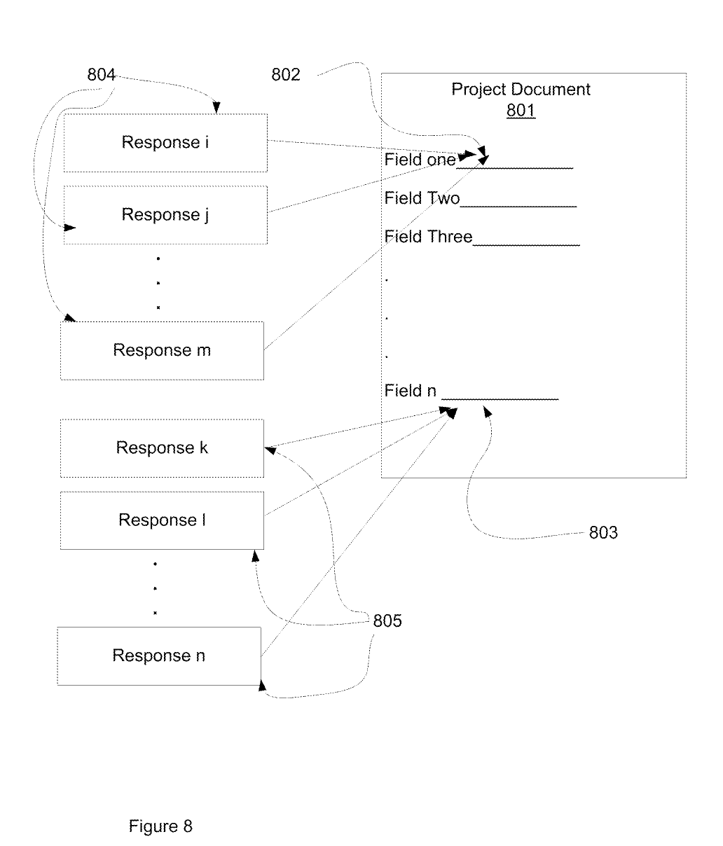

FIG. 6 shows a web page implementation of an embodiment of the specification interview process. A button selection 601 selects the specification phase of the project. Questions 602, each have a response field 603 formatted for the required type response. Responses may be for example dates 603, yes or no 604 or essay type dialog 605. Each question includes a help button 606 to provide guidance to the responder such that the response may fit into the categorical schema of the present invention. If the help dialog is insufficient an intervention process may be initiated 608 that allows non-automated personal intervention help to complete the interview dialog. Once the responses to the question set are complete the save and continue action 607 stores the responses, categorizes the responses and selects the categorically appropriate question set for the next round of interview questions that are displayed on a subsequent page of interview questions. The process continues as described in FIG. 5. FIG. 7 shows an exemplary implementation of a help embodiment of the invention. The question 701 is a query regarding hardware and sensors. A help button 702 causes a help window to pop up 703 wherein the responses, although in an open dialog mode, are defined into two categories: 1. Projects that contain lots of different instruments and 2. Projects that contain lots of different sensors. The particular categorical answers will then lead to a subsequent particular question sets specific to each category on following pages of a specification interview. In another embodiment shown in FIG. 8, the Project Document 801 comprised of a set of fields 802 is automatically filled out by selecting responses 804 to interview questions. One or more responses may be used to provide the content of the project document. In the examples shown responses i, j, m are used to provide the data for input to field one 802. A second field 803 may use a different set of responses k, l, n 805. In this manner a preprogrammed interview set may be used to create a customized specification document for the project. The help function already discussed guides the responder to provide the most relevant responses to particular interview questions and further refines the interview on-the-fly to create a complete project specification document.

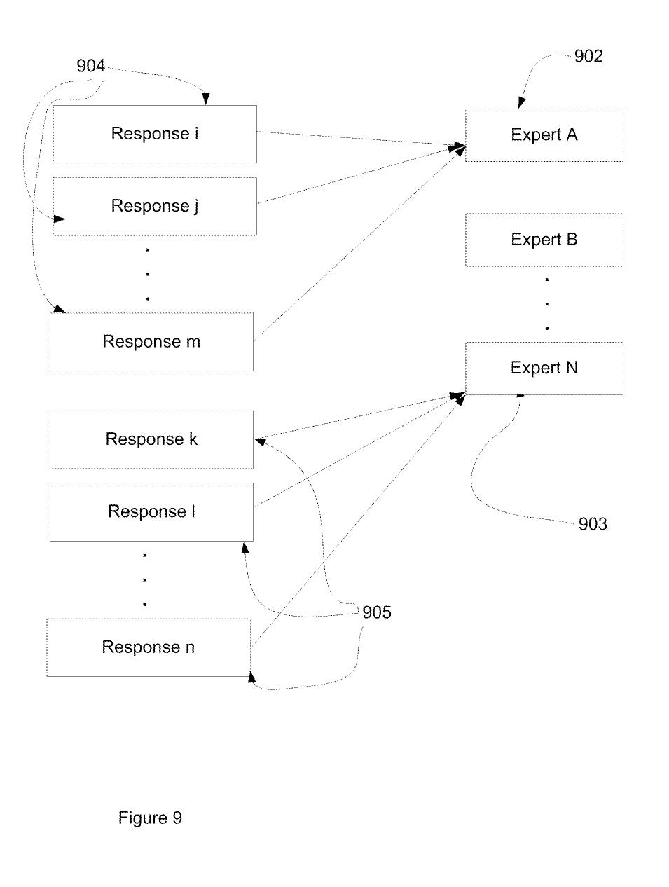

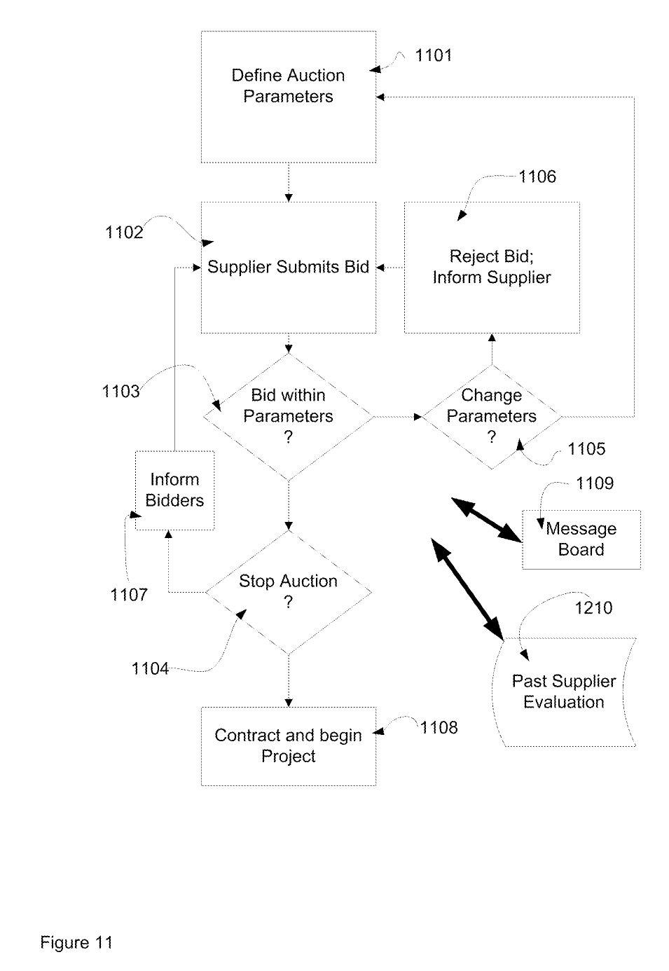

An advantage of the automated system is that it allows experts in particular areas of product testing to maintain their focus on their area of expertise. The intelligent automated system of the invention either replaces or extends the ability of the test project manager to handle more projects through ensuring specifications are well written and complete. The process provides a standardization of the product test specification such that the various experts will quickly and easily recognize what is required for each particular project enabling accurate bidding on the costs of providing the service and consistent delivery of the objectives of the product test. In another embodiment of the invention shown in FIG. 9, responses 904, 905 to the interview are preprogrammed to trigger a flag that a particular expert 902, 903 is required for the project. In another embodiment the customer can intervene to specify the need for a particular expert or a particular type of expert. As a non-limiting example responses 904, that are a subset of all responses in the specification interview process may indicate an expert in a particular type sensor is required. Other responses 905 may indicate that a different or additional expert 903 such as a particular data base expert is required. The automated system thus allows experts to focus on their areas of expertise and turns a process that once required a test project engineer or manager to be an expert in multiple areas to an assembly line of experts each efficiently contributing to the product test process. Once the project has been specified a supplier or set of suppliers is then typically selected to complete the product test design, construction of required equipment and implementing test procedures. Another embodiment of the invention automates the selection process of the suppliers. The specification interview process, already described, generates a specification document. Included in this document is a set of criteria 1001 for suppliers. The criteria document information is gathered during the specification interview process already described and the criteria document is generated as described in the discussion of FIG. 8. Supplier criteria information gathered during the specification interview such as technology and skill set requirements are matched with a database of previous project information 1210 to provide means to filter 1002 the known set of suppliers to a subset. A first test 1003 is made with the customer to determine adequacy of the selected supplier set. The test includes desired size of the bidding population of suppliers, location of suppliers as well as a check for any conflicts. A supplier might be eliminated for a past experience with the customer and also might be eliminated for a conflict of interest wherein the supplier does test programs for a direct competitor of the customer. Once a supplier set is selected a subset of the specification previously generated is distributed to suppliers through an initial contact 1004. The suppliers then decide whether they would like to bid on the project and a test 1005 is made as to whether a sufficient set of suppliers are interested. In another embodiment the supplier response creates a legally binding contract between the system host and the supplier such that the supplier is contractually bound to continue this particular customer interaction within the bounds of this test project management system, If there is a sufficient set the complete project description is forwarded and the bidding process is begun 1006. If there is not a sufficient set either the supplier selection criteria is reevaluated 1001 or the previous step where suppliers were eliminated 1003 is re-evaluated. In another embodiment the auction parameters 1101 discussed in conjunction with FIG. 11 are known by the suppliers.

Another embodiment of the invention includes a negotiation process with the selected supplier subset as depicted in FIG. 11. A set of auction parameters are first defined 1101. Exemplary parameters include maximum allowable bid, minimum bid increments, the timing allowed between submitting second bids, and the information that is given to bidders. In one embodiment all bid parameters except the start time for the auction are pre-set. The customer sets the start time for the auction. In another embodiment the timing allowed between bids is at least 24 hours. Such long time restrictions encourage bidders to be more accurate in their bids and make the pseudo reverse auction process more efficient. In another embodiment the bids may be changed by no more than 10%. In a preferred embodiment the time increment between bids is at least 24 hours and a new bid may differ from the previous bid by no more than 10%. Once parameters are defined a supplier submits a bid 1102. In one embodiment the submitted bid may simply be a price to complete the project as defined in the specification created through the already described interview process. In another embodiment the submitted bid includes refinements to the specification including suggested new milestones and organization of the project into sub-projects. In a preferred embodiment the bid is a full proposal for completion of the project including deliverables, timing costs and tracking milestones. Another embodiment includes a message board 1109. A bidder may post questions to the message board regarding the project. These questions and the answers are available to all bidders to ensure fairness of the auction process. In another embodiment, the auction parameters definition 1101 sets requirements for the type of bid that is acceptable. A check 1103 is made as to whether the bid falls within the allowable parameter ranges. If not within the parameter ranges, a decision can be made as to whether to change the parameters 110 to make the bid acceptable or reject the bid and inform the bidding supplier 1106. If an acceptable bid is received the customer may then decide whether to stop or continue the auction 1104. The Decision is made on not only the bid itself, but also the database of past evaluations of the suppliers 1210. In another embodiment the database 1210 is also continuously updated based upon actions occurring during the auction process. Information such as the amount of the bid and the ranking of the bid amongst all bidders is recorded and used as part of the feedback profile for the bidders. The arrows for the database 1210 and the message board 1109 purposefully do not point to a particular step in the process. The interaction with these embodiments may take place through any of the many steps of the supplier selection process. The embodiment wherein the customer may stop the auction 1104 after receiving even just a single bid improves the efficiency of the bidding process by forcing bidders to supply their best offer early in the bidding process. If the customer decides to continue the process and accept additional bids the bidders are informed 1107 of the continuing auction status and bidding continues 1102. The information shared with the bidders at point 1107 is selected as part of the general auction parameters 1101. In a preferred embodiment the bidders are informed only if their bid has been accepted and not whether it is a high or low bid compared to other bidders. In another embodiment bidders are informed of the current low bid for the project. Once the customer decides 1104 to stop the bidding, a contract is completed based upon the project specifications and the implementation phase of the project is begun 1108.

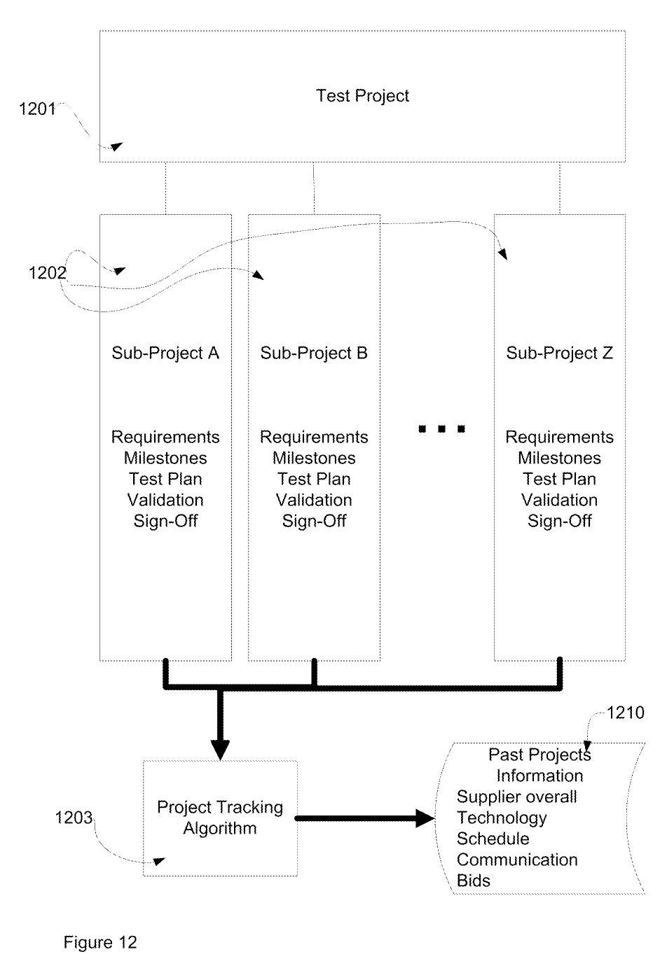

Another embodiment of the invention includes automation to aid in the project implementation management, FIG. 12. The project has been defined 1201 on an overall basis and in terms of sub-projects 1202. The sub-projects may be identified with particular experts selected as described in the discussions of FIG. 9. In another embodiment the project is sub-divided into temporal phases that should be completed sequentially. In a preferred embodiment the project is defined into sub-projects, each of which are identified as a different technology required to complete a test project. Exemplary technology sub-projects include software, hardware, sensor and data base management. Each of the sub-projects may be managed separately and feed progress and result information into a project tracking algorithm embodiment 1203. The project tracking algorithm creates a dashboard described below that allows all stakeholders to track progress of the overall project as well as individual sub-projects. Project evaluation information is captured 1210 as the project progresses. In one embodiment the completion of milestones is evaluated by capturing within a database the fields of:

Name of milestone
Description of milestone
Targets start date
Actual start date
Supplier comment re start date
Customer comment re start date
Target completion date
Actual completion date
Supplier comment re completion

Algorithms are defined such both objective and subjective data may be compiled into an overall evaluation that is included in the supplier database. In a preferred embodiment the past project evaluations include a numeric scale rating of the project parameters of: Overall Satisfaction Rating, Technology Rating, Schedule Rating, Communication Rating, and Bid Ranking. The past project rating is used as already described to aid in the initial project definition phase and for selection of suppliers that are appropriate for the project by comparison of the current project specification including priorities and past project evaluations.

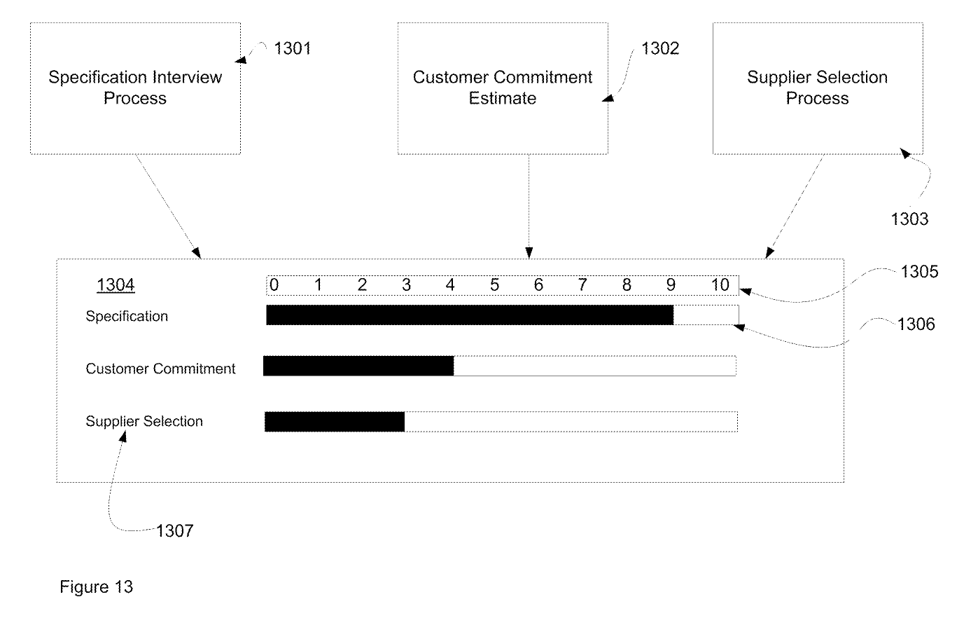

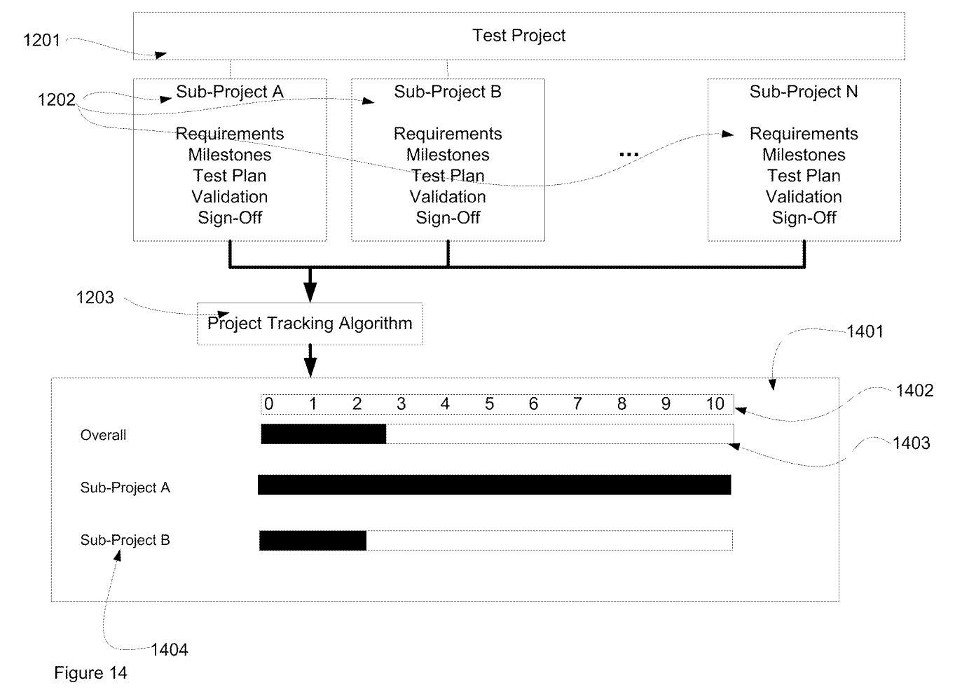

FIGS. 13 and 14 show depictions of dashboard embodiments of the invention. Prior to supplier selection a dashboard as described in FIG. 13 is applicable. The Specification interview process 1301, a customer commitment estimate 1302 and the supplier selection process 1303 all feed information into the dashboard algorithm embodiment. Prior test project experience allows an algorithm to translate completion of the automated interview process and gathering of input documents to create a specification to be scaled as a percentage completion of the specification process. Similarly the output parameters of the supplier selection process 1303 may likewise be scaled to provide a linear indicator of percentage completion of that phase of a test project. The dashboard embodiment provides these linearization algorithms as well as a display 1304 shown in FIG. 13 of the completion progress of the monitored project parameters 1306. Completion of each of the metrics is displayed 1306 against a linear numeric scale 1305. A customer commitment estimate is an estimate of the likelihood the customer will carry through on the project by completing a specification and actually accepting bids and completing the project. The estimate is a probability test of whether the customer is committed to hiring a supplier for the test project or the customer is simply “window shopping”. In one embodiment the customer commitment estimate is calculated on the basis of whether the start date and completion dates are reasonable based upon experience with past projects of similar scope, whether the first estimated cost is reasonable based upon experience with past projects of similar scope. In another embodiment specification creation consultation help is made available to the customer at a nominal fee. Past experience has shown that the more committed customer consistently takes advantage of this offer and less committed customers do not. The Customer Commitment rating is increased if the customer accepts the offer and is decreased if they do not. Another embodiment of the invention includes a progress tracking dashboard and associated algorithms as depicted in FIG. 14. Again the overall project 1201 is divided as described earlier into sub-projects 1202. Each sub-project consists of the generic process steps of defining requirements, defining milestones, creating the test plan, validation of the test procedures and sign-off of the previous four steps. Progress against these process steps for each sub-project is defined through a project tracking algorithm 1203 that provides a linear in time and effort output for the progress against the generic process steps. A display embodiment of the invention provides a progress tracking dashboard 1401 consisting of a linear scale and progress for the overall and each sub-project 1404 shown on a linear completion scale 1403. In one embodiment the linearization algorithm defines completion of the requirements as 35% overall complete, completion of the implementation milestones another 40% towards overall completion, validation represents another 10% of completion, test plans comprise 10% and sign-off 5%. Thus in the example of FIG. 14 the sub-project A has completed sign-off whereas the sub-project B has completed about ⅔ of the requirements for the sub-project B. The Overall completion is a weighted average of all of the sub-projects. In one embodiment the weighting is the initial time estimate for the sub-project relative to the time estimate for the overall project.

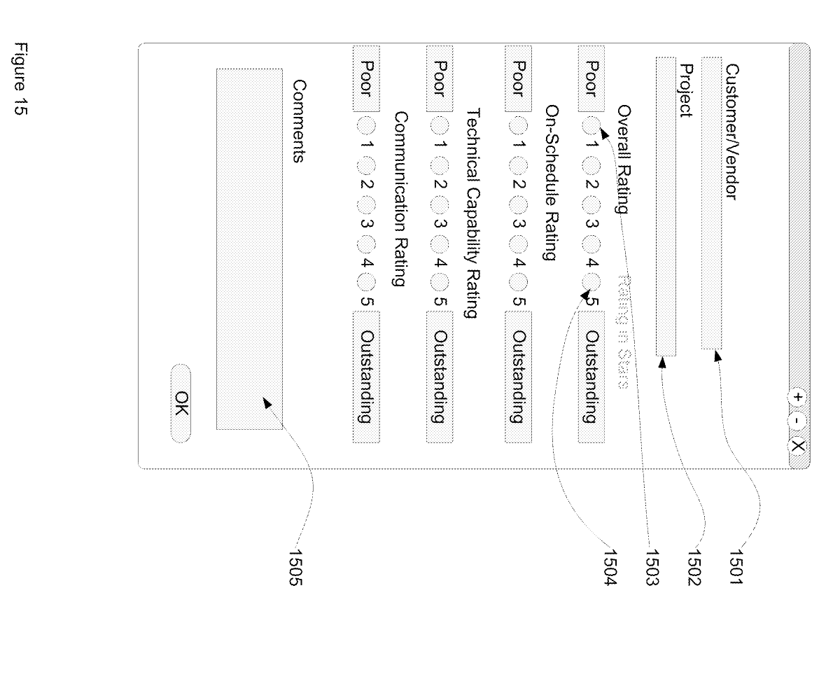

An evaluation embodiment of the invention is shown in FIG. 15. The embodiment may be used upon completion of the project or completion of a phase of the project or completion of any step in a phase of the project. The customer identifies themselves 1501 and the project and phase upon which comments are to be made 1502. The comments are solicited as a 1 to 5 scale 1504, 1505 in categories 1503. In a preferred embodiment the categories include overall, On-schedule, technical capability and communication. Comments 1506 are also solicited thus allowing amplification on categorical ratings or inclusion of factors related to ratings not captured in a strict categorical 1 to 5 rating scheme. The information captured is included in a database 1210, previously discussed in conjunction with FIG. 12 as well as other Figures.

### CONCLUSIONS

Test system project management processes, algorithms and software are described. The combination of the processes, algorithms and software provides a means to effectively management new the testing procedures for new product introductions from initial specification of the testing requirements all the way through implementation. The automated system allows the work to be broken down into defined sub-projects such that individual experts will have defined and documented tasks contributing to the completion of the testing regime. Tracking and evaluation algorithms are also presented. The system has been found to reduce the risk of new product introductions through thorough documentation and monitored implementation. The system also includes negotiation schema that provide optimized supplier selection to design and complete the testing system at an effective cost.

I claim:

1. An automated test system program comprising:
a) an interview process comprising programmed questions and customer responses that defines specifications for a customer's product to be tested and specifications for a required test system.

2. The test system program of claim 1 wherein the specifications include hardware and software specifications for the product and hardware and software specifications for the required test system.

3. The test system program of claim 1 further comprising a help program comprising suggested customer responses in the interview process.

4. The test system program of claim 3 where the interview process further comprises a program to modify later questions based upon responses to earlier questions.

5. The test system program of claim 4 wherein the suggested responses are categorical responses that allow later questions to be selected based upon the set of categorical responses to earlier questions.

6. The test system program of claim 1 where the interview process automatically creates a specification document.

7. The test system program of claim 1 wherein the interview process includes automatic selection of experts based upon responses to questions.

8. The test system program of claim 1 further comprising:
a) a supplier selection process to select a supplier or set of suppliers,
b) an implementation process including algorithms for a dashboard status report, and
c) an evaluation process.

9. The test system program of claim 8 where the supplier selection process includes a reverse pseudo auction negotiation process.

10. The test system program of claim 9 wherein the reverse pseudo auction includes rules limiting the maximum bid, the increment between bids and the time between bids.

11. The test system program of claim 10 wherein the increment between bids is limited to no more than 10% and the time between bids is at least 24 hours.

12. The test system program of claim 8 where the supplier selection process automatically generates a binding contract between suppliers and the customer.

13. The test system program of claim 8 wherein the supplier selection process further includes a message board available to the suppliers for project specification inquiries.

14. The test system program of claim 8 where the dashboard status report further comprises a customer commitment index.

15. The test system program of claim 14 wherein the customer commitment index is at least partially based upon whether the customer pays for expert advice.

16. The test system program of claim 8 where the specifications include milestones, validation requirements for completion of milestones, and a sign-off process for completion of milestones.

17. The test system program of claim 16 where the dashboard status report further comprises a project completion algorithm.

18. The test system program of claim 17 where the project completion algorithm weights the completion of the specifications at about 35%, completion of the implementation milestones at about 40%, completion of the validation process at about 10%, completion of test plans at about 10% and completion of the sign-off process at about 5%.

19. The test system program of claim 8 wherein the evaluation process automatically creates a database of past assessments of project success.

20. The test system program of claim 19 wherein the database includes customer ratings for overall project success, on-schedule, suppliers' technical skills, suppliers' communication skills and rankings of suppliers as to cost bids.

21. The test system program of claim 20 wherein the database information is available to the customer during the interview process, the supplier selection process, the implementation process and the evaluation process.

22. The test system program of claim 21 wherein the customer may update the database during the interview process, the supplier selection process, the implementation process and the evaluation process.

23. A networked computing system programmed to provide an automated test system program comprising:
a) an interview process comprising programmed questions and customer responses that defines specifications for a customer's product to be tested and specifications for a required test system.

24. The computing system of claim 23 wherein the specifications include hardware and software specifications for the product and hardware and software specifications for the required test system.

25. The computing system of claim 23 further comprising a help program comprising suggested customer responses in the interview process.

26. The computing system of claim 25 where the interview process further comprises a program to modify later questions based upon responses to earlier questions.

27. The computing system of claim 26 wherein the suggested responses are categorical responses that allow later questions to be selected based upon the set of categorical responses to earlier questions.

28. The computing system of claim 23 where the interview process automatically creates a specification document.

29. The computing system of claim 23 wherein the interview process includes automatic selection of experts based upon responses to questions.

30. The computing system of claim 23 further comprising:
a) a supplier selection process to select a supplier or set of suppliers,
b) an implementation process including algorithms for a dashboard status report, and
c) an evaluation process.

31. The computing system of claim 30 where the supplier selection process includes a reverse pseudo auction negotiation process.

32. The computing system of claim 31 wherein the reverse pseudo auction includes rules limiting the maximum bid, the increment between bids and the time between bids.

33. The computing system of claim 32 wherein the increment between bids is limited to no more than 10% and the time between bids is at least 24 hours.

34. The computing system of claim 30 where the supplier selection process automatically generates a binding contract between suppliers and the customer.

35. The computing system of claim 30 wherein the supplier selection process further includes a message board available to the suppliers for project specification inquiries.

36. The computing system of claim 30 where the dashboard status report further comprises a customer commitment index.

37. The computing system of claim 36 wherein the customer commitment index is at least partially based upon whether the customer pays for expert advice.

38. The computing system of claim 30 where the specifications include milestones, validation requirements for completion of milestones, and a sign-off process for completion of milestones.

39. The computing system of claim 38 where the dashboard status report further comprises a project completion algorithm.

40. The computing system of claim 39 where the project completion algorithm weights the completion of the specifications at about 35%, completion of the implementation milestones at about 40%, completion of the validation process at about 10%, completion of test plans at about 10% and completion of the sign-off process at about 5%.

41. The computing system of claim 30 wherein the evaluation process automatically creates a database of past assessments of project success.

42. The computing system of claim 41 wherein the database includes customer ratings for overall project success, on-schedule, suppliers' technical skills, suppliers' communication skills and rankings of suppliers as to cost bids.

43. The computing system of claim 42 wherein the database information is available to the customer during the interview process, the supplier selection process, the implementation process and the evaluation process.

44. The computing system of claim 43 wherein the customer may update the database during the interview process, the supplier selection process, the implementation process and the evaluation process.

45. A computer readable memory device upon which is encoded a computer program to implement an automated test system comprising:
a) an interview process comprising programmed questions and customer responses that defines specifications for a customer's product to be tested and specifications for a required test system.

46. The memory device of claim 45 wherein the specifications include hardware and software specifications for the product and hardware and software specifications for the required test system.

47. The memory device of claim 45 further comprising a help program comprising suggested customer responses in the interview process.

48. The memory device of claim 47 where the interview process further comprises a program to modify later questions based upon responses to earlier questions.

49. The memory device of claim 48 wherein the suggested responses are categorical responses that allow later questions to be selected based upon the set of categorical responses to earlier questions.

50. The memory device of claim 45 where the interview process automatically creates a specification document.

51. The memory device of claim 45 wherein the interview process includes automatic selection of experts based upon responses to questions.

52. The memory device of claim 45 further comprising:
a) a supplier selection process to select a supplier or set of suppliers,
b) an implementation process including algorithms for a dashboard status report, and
c) an evaluation process.

53. The memory device of claim 52 where the supplier selection process includes a reverse pseudo auction negotiation process.

54. The memory device of claim 53 wherein the reverse pseudo auction includes rules limiting the maximum bid, the increment between bids and the time between bids.

55. The memory device of claim 54 wherein the increment between bids is limited to no more than 10% and the time between bids is at least 24 hours.

56. The memory device of claim 52 where the supplier selection process automatically generates a binding contract between suppliers and the customer.

57. The memory device of claim 52 wherein the supplier selection process further includes a message board available to the suppliers for project specification inquiries.

58. The memory device of claim 52 where the dashboard status report further comprises a customer commitment index.

59. The memory device of claim 58 wherein the customer commitment index is at least partially based upon whether the customer pays for expert advice.

60. The memory device of claim 52 where the specifications include milestones, validation requirements for completion of milestones, and a sign-off process for completion of milestones.

61. The memory device of claim 60 where the dashboard status report further comprises a project completion algorithm.

62. The memory device of claim 61 where the project completion algorithm weights the completion of the specifications at about 35%, completion of the implementation milestones at about 40%, completion of the validation process at about 10%, completion of test plans at about 10% and completion of the sign-off process at about 5%.

63. The memory device of claim 52 wherein the evaluation process automatically creates a database of past assessments of project success.

64. The memory device of claim 63 wherein the database includes customer ratings for overall project success, on-schedule, suppliers' technical skills, suppliers' communication skills and rankings of suppliers as to cost bids.

65. The memory device of claim 64 wherein the database information is available to the customer during the interview process, the supplier selection process, the implementation process and the evaluation process.

66. The memory device of claim 65 wherein the customer may update the database during the interview process, the supplier selection process, the implementation process and the evaluation process.
